(19) United States
(12) Patent Application Publication
(10) Pub. No.: US 2006/0071918 A1
(43) Pub. Date: Apr. 6, 2006

(54) Input device

(76) Inventors: Eijiro Mori, Tokyo (JP); Takuo Ikeda, Tokyo (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 11/228,622

(22) Filed: Sep. 16, 2005

(30) Foreign Application Priority Data
Oct. 5, 2004 (JP) 2004-292921

(51) Int. Cl. G09G 5/00

(52) U.S. Cl. 345/184

(57) ABSTRACT

The present invention has been made to allow a user to intuitively select desired data from a large amount of data. The present invention provides an input device including an attribute information storage section that stores attribute information of contents, a virtual map creation section that creates a virtual map by allocating, in units of attribute information, icons that represent the contents based on the attribute information, a movement amount detection section that detects a physical movement amount of the input device, a display controller that calculates the movement amount on the virtual map from the physical movement amount detected by the movement amount detection section and allows a display section to display a predetermined area of the virtual map whose center is the position of the input device on the virtual map after movement, and an input section that inputs identification information of the content corresponding to the icon displayed on the predetermined area as input data when receiving an instruction from a user.

### CROSS REFERENCE TO RELATED APPLICATIONS

The present invention contains subject matter related to Japanese Patent Application JP 2004-292921 filed in Japanese Patent Office on Oct. 5, 2004, the entire contents of which being incorporated herein by reference.

### BACKGROUND OF THE INVENTION

1. Field of the Invention

The present invention relates to an input device that receives an input from a user.

2. Description of the Related Art

In recent years, a short-range network using a local area wireless communication such as wireless LAN or BlueTooth (Registered Trademark) has become popular. In such a network, data is not stored in respective machines, but is collectively managed by a server. A user can download desired data from the server as needed.

In the above environment, it becomes unnecessary for a client serving as an input device to have an auxiliary recording means for storing data or a reproduction mechanism of a recording medium, increasing flexibility in the shape thereof. Further, in the case where data is collectively managed by the server, the server stores an enormous amount of data. In order to effectively perform searching of an enormous amount of data, the client requires a shape or function according to the use environment.

FIGS. 1 and 2 each shows a data search window on a conventional electronic apparatus. FIG. 1 is a search window of music contents, which has a hierarchy structure. By specifying attribute such as “artist name”, “music name”, “category”, or the like, it is possible to narrow the numbers of the music contents (refer to, for example, Jpn. Pat. Appln. Laid-Open Publication No. 2001-264102). In FIG. 2, data is plotted on a map. A user inputs moving direction such as “left”, “right”, “top”, or “bottom” or scale size through a button or joystick provided with the apparatus to search target information (refer to, for example, Jpn. Pat. Appln. Laid-Open Publication No. 2002-319271).

### SUMMARY OF THE INVENTION

The search method of Jpn. Pat. Appln. Laid-Open Publication No. 2001-264102 is premised on that the user previously knows information such as “artist name” or “music name”. The user images the music to be searched and narrows down search conditions to find a specific music. This search method corresponds to categories of the music contents such as “artist”, “album”, or “music name” and, therefore, can be said to be an excellent search method in the case where the user's search target is clear. However, in the case where the user does not know search condition, he or she cannot narrow the number of search targets, resulting in failure to find the target music content. In particular, the server stores thousands of, or tens of thousands of music contents. Accordingly, it is necessary to memorize “artist name” or “music name” of an enormous amount of the music contents and narrow down the search condition. This is a burden to the user. Further, in this search method, it is difficult to overview the music contents stored in the server.

In the search method of Jpn. Pat. Appln. Laid-Open Publication No. 2002-319271, the use of the joystick or button itself becomes a problem. Further, it is hard to grasp a relationship between objects on the map and indicators or a relationship between operation amount on the apparatus and movement amount on the display.

The present invention has been made in view of the above problems, and it is desirable to provide an input device allowing a user to intuitively select desired data from a large amount of data.

According to the present invention, there is provided an input device comprising: an attribute information storage means for storing attribute information of contents; a virtual map creation means for creating a virtual map by allocating, in units of attribute information, icons that represent the contents based on the attribute information; a movement amount detection means for detecting a physical movement amount of the input device; a display control means for calculating the movement amount on the virtual map from the physical movement amount detected by the movement amount detection means and allowing a display means to display a predetermined area of the virtual map whose center is the position of the input device on the virtual map after movement; and an input means for inputting identification information of the content corresponding to the icon displayed on the predetermined area as input data when receiving an instruction from a user.

According to the present invention, there is also provided an input device comprising: a cylindrical casing; a bezel portion rotatably fitted to the upper edge of the casing; a movement amount detection means for detecting the amount of the planar movement of the casing; an attribute information storage means for storing attribute information of contents; a virtual map creation means for creating a virtual map by allocating, in units of attribute information, icons that represent the contents based on the attribute information; a display control means for calculating the movement amount on the virtual map from the physical movement amount and allowing a display means to display a predetermined area of the virtual map whose center is the position of the input device on the virtual map after movement; and an input means for inputting identification information of the content corresponding to the icon displayed on the predetermined area as input data when receiving an instruction from a user.

The input device according to the present invention creates a virtual map by allocating, in units of attribute information, icons that represent the contents based on attribute information of the contents, calculates the movement amount on the virtual map from the physical movement amount of the input device, allows a display means to display a predetermined area of the virtual map whose center is the position of the input device on the virtual map after movement, and inputs identification information of the content corresponding to the icon displayed on the display means as input data. According to the input device of the present invention, the operation of sliding the device and the operation of virtually moving the device on the virtual map are associated with each other, so that the user can intuitively operate the device without the need of learning the operation method. Further, the input device according to the present invention presents the user the virtual map on which contents are classified in terms of age, category, atmosphere, or the like. Even if the user does not know the correct name of the content, he or she can select the content.

The input device according to the present invention includes a cylindrical casing, a bezel section rotatably fitted to the upper edge of the casing, and a movement amount detection means for detecting the amount of the planar movement of casing, creates a virtual map by allocating, in units of attribute information, icons that represent the contents based on attribute information of the contents, calculates the movement amount on the virtual map from the physical movement amount of the input device, allows a display means to display a predetermined area of the virtual map whose center is the position of the input device on the virtual map after movement, and inputs identification information of the content corresponding to the icon displayed on the display means as input data. Since the input device according to the present invention is a small type device, the user can always keep it around. Further, since the input device can be operated on a flat face like a table, it is possible for the user to easily enjoy the music selection operation while relaxing on the sofa or working on the desk.

### BRIEF DESCRIPTION OF THE DRAWINGS

FIG. 1 is a view showing a search window in a conventional electronic apparatus;

FIG. 2 is a view showing a search window in a conventional electronic apparatus;

FIG. 3 is a view showing an exterior view of an input device according to the present invention;

FIG. 4 is an exploded perspective view of the input device according to the present invention;

FIG. 5 is a top view of the input device according to the present invention;

FIG. 6 is a block diagram showing an internal configuration of the input device according to the present invention;

FIGS. 7A to 7C are views each showing an example of a music map;

FIG. 8 is a view showing a state where the input device is slid;

FIG. 9 is a view showing a state where a bezel portion is rotated;

FIG. 10 is a view showing a state where a bezel portion is depressed;

FIG. 11 is a flowchart showing a procedure of a music reproduction operation;

FIG. 12 is a view showing a relationship between the input device and server; and

FIG. 13 is a view showing another configuration of the input device.

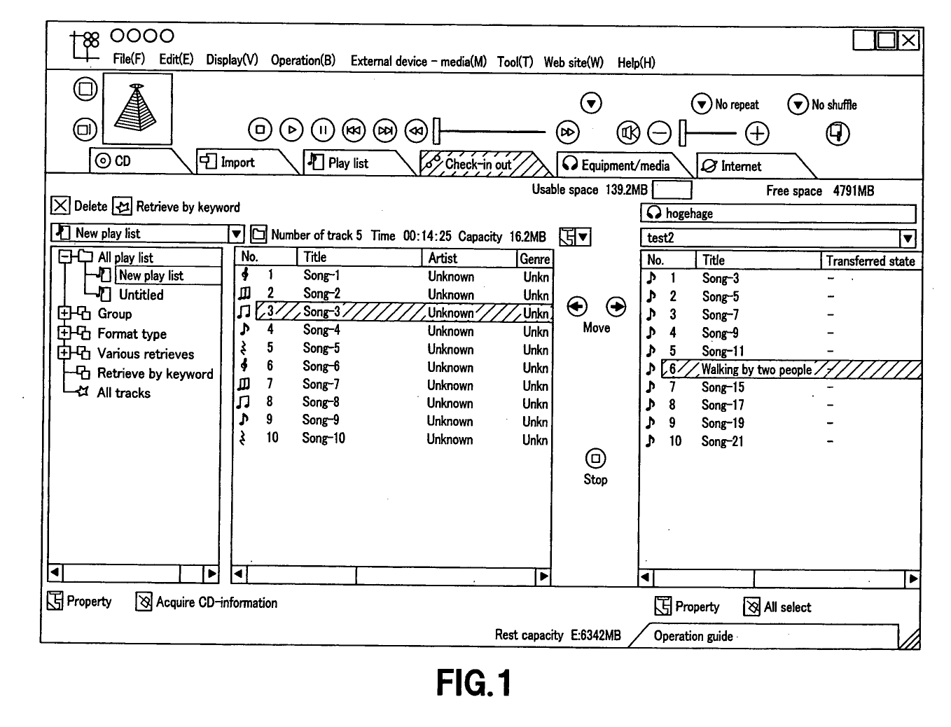

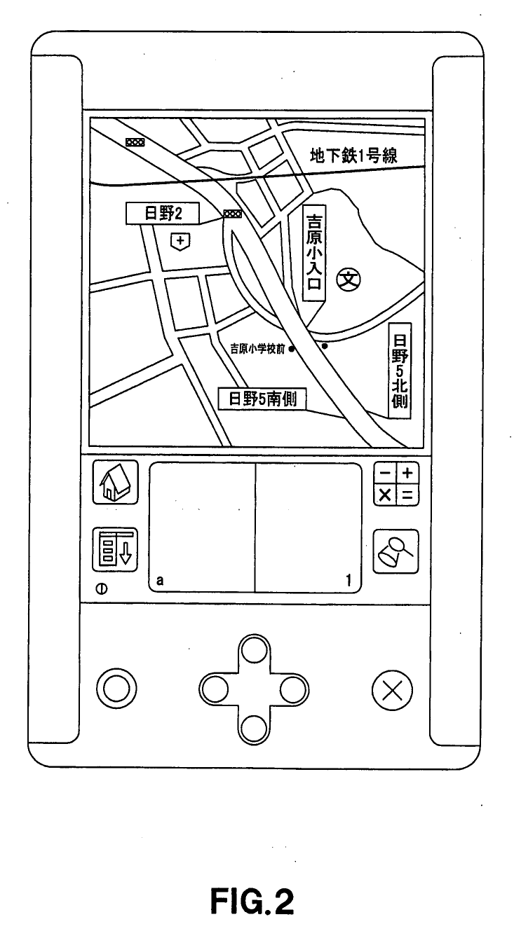

### DETAILED DESCRIPTION OF THE PREFERRED EMBODIMENTS

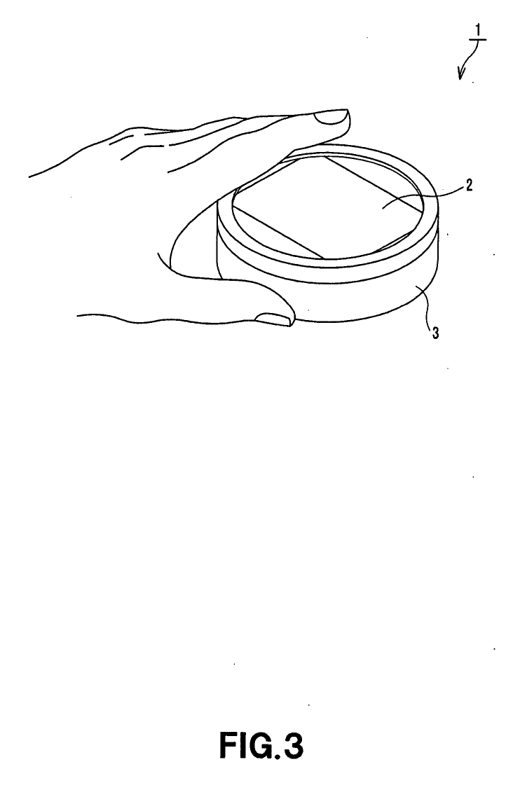

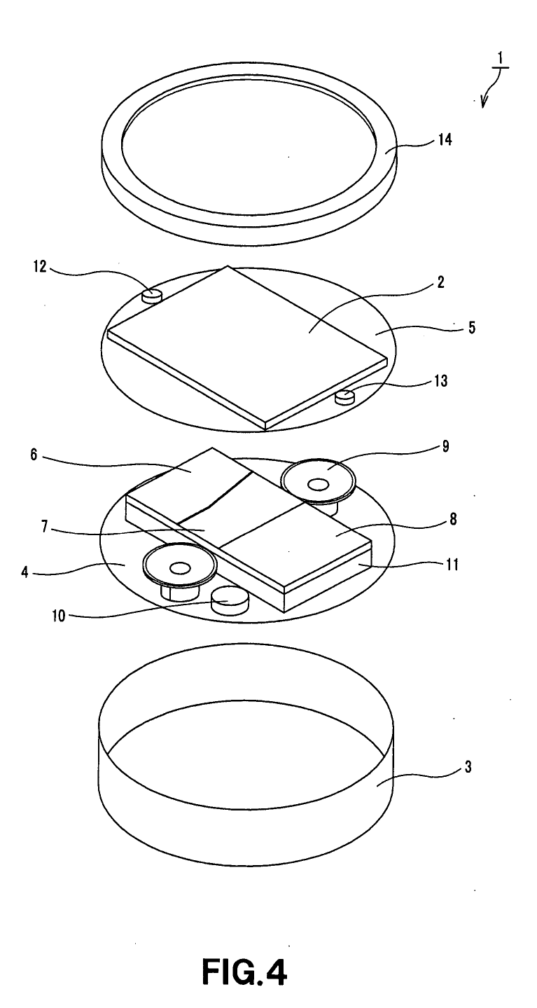

Hereinafter, an input device 1 according to the present invention will be described with reference to the accompanying drawings. In this example, the input device 1 is used to select music content. FIG. 3 shows an exterior view of the input device 1, and FIG. 4 is an exploded perspective view of the input device 1. The input device 1 has a cylindrical shape and includes a display section 2 on the upper surface thereof. The input device 1 is a small enough to be fit in the palm of human hand and can be slid on a plain surface such as a table by one hand. Two base plates 4 and 5 are housed in a cylindrical casing 3 serving as an exterior covering of the input device 1. The two base plates 4 and 5 are disposed vertically in the casing 3. Mounted on the lower base plate 4 are a controller 6 that controls the input device 1, a communication section 7 serving as an interface for communicating with an electronic apparatus on a network, an amplifier 8 that amplifies music data of the music content received by the communication section 7, a speaker 9 that produces the music data amplified by the amplifier 8, an optical sensor 10 that detects the movement amount, direction, and speed of the input device 1, and a battery 11. On the upper base plate 5, a switch 12 for receiving a user's input and display section 2 for displaying an input target or apparatus state are mounted.

A bezel portion 14 is fitted to the upper edge of the casing 3. The bezel portion 14 has a ring-shape. As shown in FIG. 5, the user can see the display section 2 through the opening of the bezel portion 14. In FIG. 5, the display section 2 displays a thumbnail image of a music album jacket. As shown in FIG. 4, a switch 12 is disposed below the bezel portion 14. When the bezel portion 14 is depressed, a pressure is applied to the switch 12 disposed below the bezel portion 14. The bezel portion 14 is rotated along the upper edge of the casing 3. The rotation amount of the bezel portion 14 is measured by a rotary encoder 13.

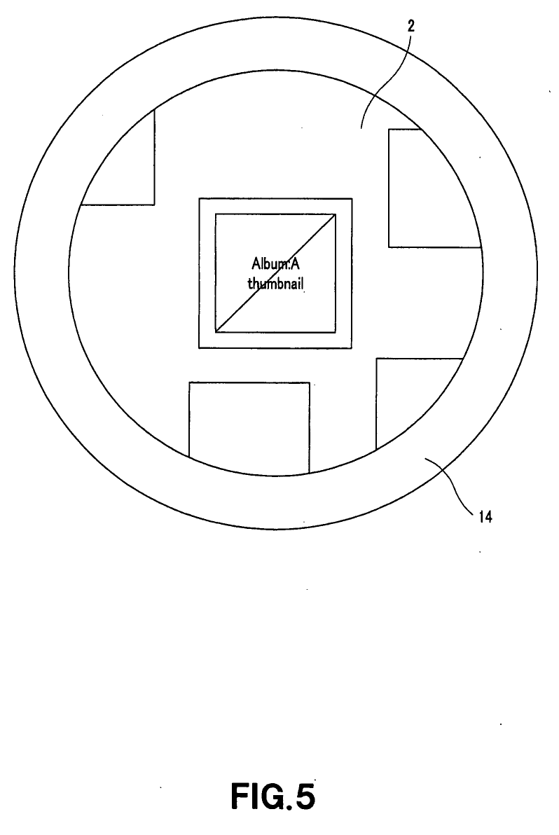

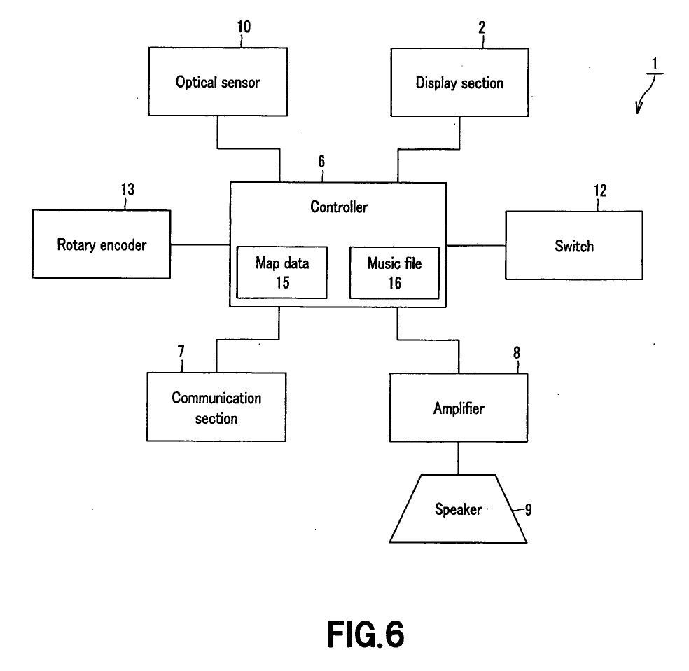

FIG. 6 is a block diagram showing an electrical configuration of the input device 1. The controller 6 receives data input from the rotary encoder 13, switch 12, optical sensor 10, and communication section 7 and outputs data to the display section 2 and amplifier 8. The controller 6 stores map data 15 and a music file 16 to be mapped on the map data 15. The music file 16 stores name of music content, ID of music content, category, creation date, record company, icon, and the like. The icon is an image representing jacket of music content, name of music content, photograph of artist, and the like. The controller 6 allocates (maps) the icons on the adequate positions on the map data 15 to create a music map serving as a virtual map.

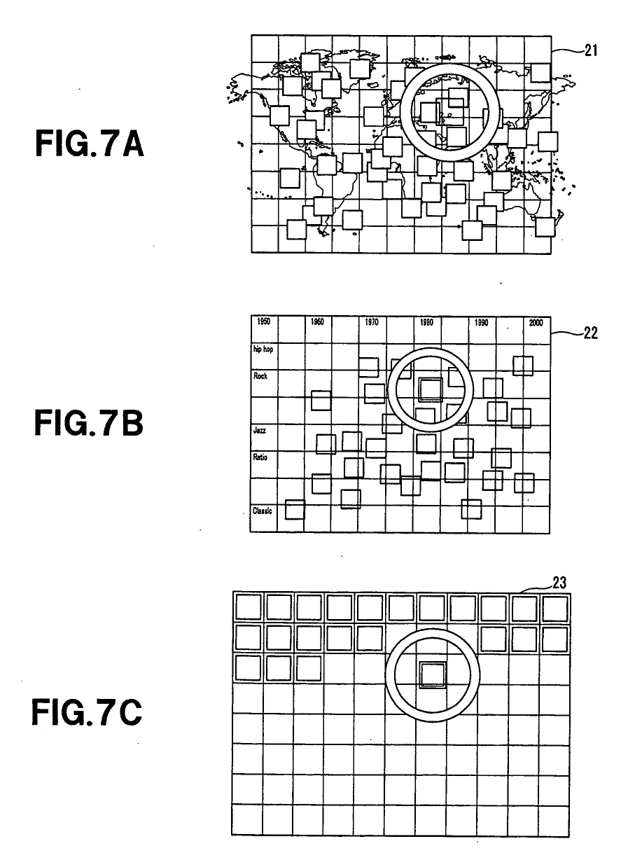

FIGS. 7A to 7C each shows an example of the music map. A music map 21 of FIG. 7A represents creation locations of music. The music map 21 is based on the map data 15, which is a global map data, and icons are mapped on predetermined positions on the map data 15. Each of the positions on which the icons are mapped represents the location where the music is created or artist's hometown. The icon is an image representing the content of music such as album jacket, name of music content.

A music map 22 of FIG. 7B represents the date on which the music is created and category to which the music belongs. The map data 15 on which the music map 22 is based has a coordinate system with the vertical axis representing the creation date and horizontal axis representing the category. The axis representing the date is plotted every ten years from 1950 to 2010. The axis representing the category is plotted to divide the map into, for example, “Hip Hop”, “Rock”, “Jazz”, “Ratin”, and “Classic”. The controller 6 maps the music icons on adequate positions to create the music map 22.

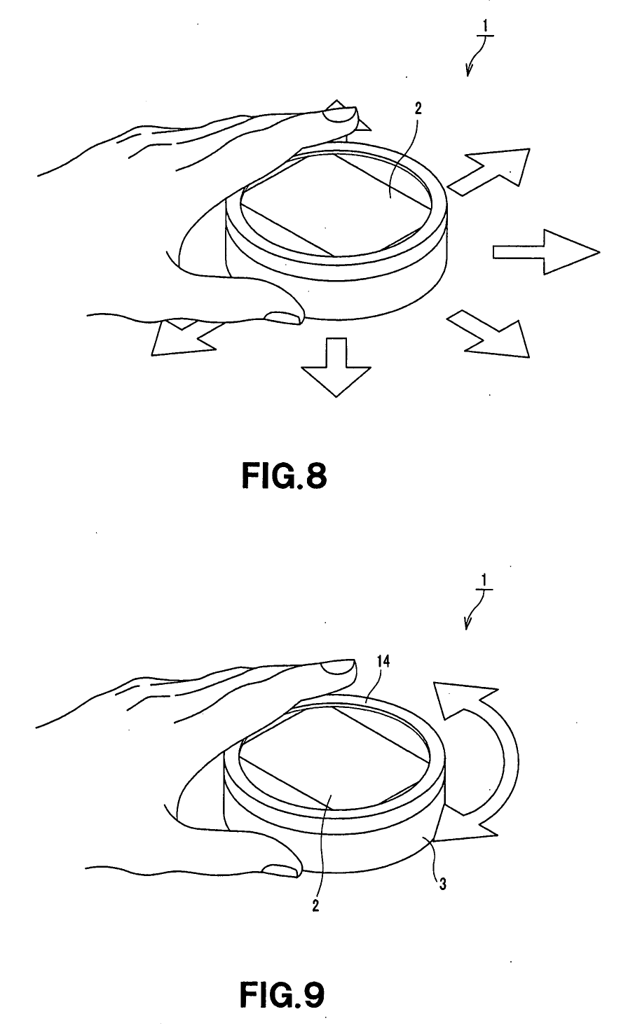

FIG. 7C is a map 23 on which the music contents are arranged in the order of artist. The name of artists and music contents are sorted in the order of the alphabet or the Japanese syllabary. Icons are mapped on the music map 23 in such a manner that “artists with initial A” are on the first column from the left, “artists with initial B” are on the second column, “artists with initial C” are on the third column The controller 6 changes the display content on the display section 2. In the input device 1, a part of the music map obtained by cutting with the coordinates of the input device 1 on the music map set as a center is displayed on the display section 2. The display content on the display section 2 is changed with the physical movement of the input device 1. As shown in FIG. 8, when the input device 1 is slid on a plain surface, the optical sensor 10 detects the movement amount, direction, speed of the input device 1. The controller 6 performs calculation in accordance with the detection result and obtains the coordinates of the input device 1 on the music map, cuts a part of the music map with the coordinates after the slide movement set as a center and allows the display section 2 to display it. The display content on the display section 2 is changed with the slide movement of the input device 1.

The user performs a search for the music icons mapped on the music map while moving the entire device. The music is often related to user's memory such as age or environment. By mapping the icons in terms of age or location, it becomes possible for the user to image the mapping on the music map based on his or her memory and thereby to intuitively perform a music search.

By making the size of a table on which the input device 1 is operated correspond to the virtual size of the music map, it is possible for the user to estimate the virtual position of the input device 1 on the music map from the actual position of the input device 1 on the table. As a result, the user can intuitively operate the input device 1.

In addition to the slide operation on a plain surface, the input device 1 receives the following two operations. The first one is an operation to rotate the bezel portion 14 of the input device 1. When the bezel portion 14 is rotated as shown in FIG. 9, the rotary encoder 13 disposed below the bezel portion 14 measures the rotation amount of the bezel portion 14. The controller 6 receives an input of the rotation amount of the bezel portion 14 and uses it, for example, for increase/decrease of the volume of the speaker 9, zoom-in/zoom-out of the image, switching of the input windows, or selection from lists.

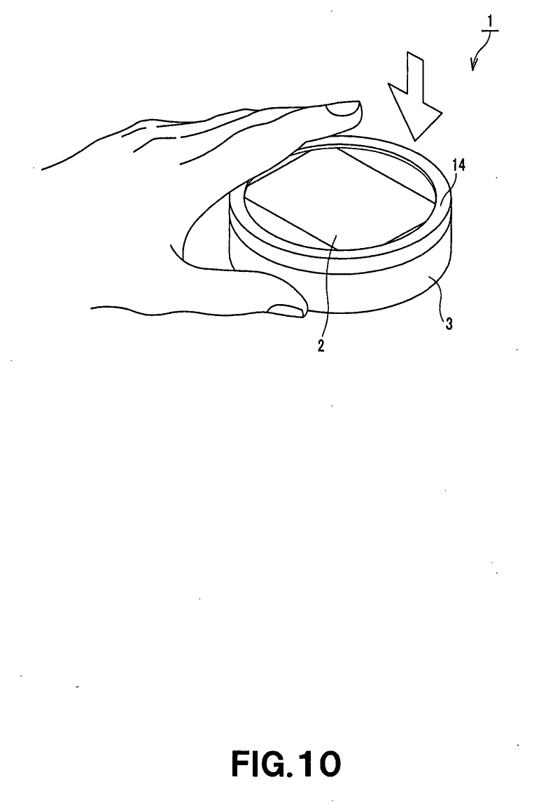

The second one is an operation to depress the bezel portion 14 of the input device 1. When the bezel portion 14 is depressed as shown in FIG. 10, the switch 12 disposed below the bezel portion 14 detects the depression and outputs it to the controller 6. Upon receiving the depression of the switch 12, the controller 6 issues an instruction to reproduce the music that is being displayed on the display section 2 or instruction to stop the music that is being reproduced.

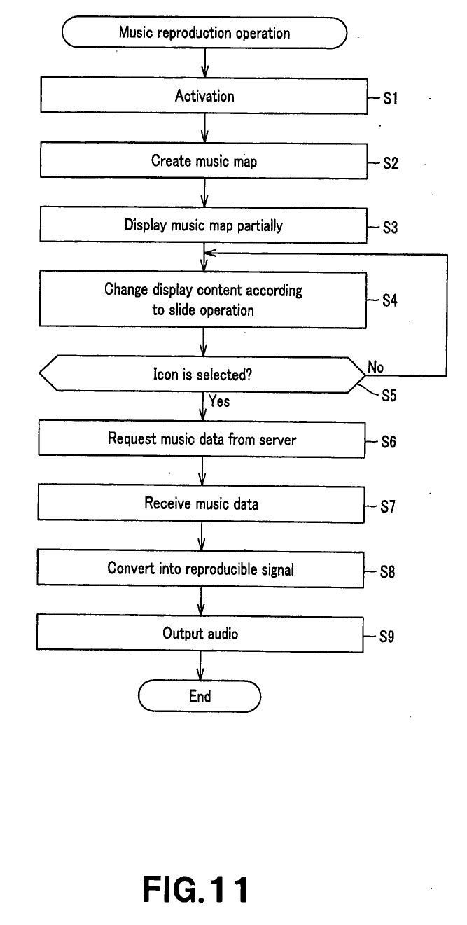

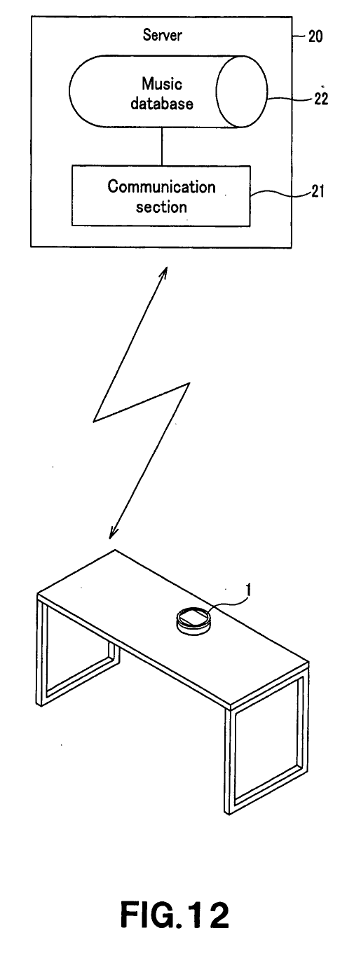

A music reproduction operation in the abovementioned input device 1 will next be described with reference to FIG. 11. The input device 1 downloads music content from the server 20. As shown in FIG. 12, the server 20 includes a communication section 7 for communicating with the input device 1 and a music database 22 for storing music contents. The server 20 and input device 1 are connected to each other through a local area wireless communication such as wireless LAN or BlueTooth (Registered Trademark).

When the input device 1 is activated (step S1), the controller 6 creates a music map based on the map data 15 and music file 16 (step S2). The controller 6 cuts a part of the music map with the coordinates of the input device 1 on the music map set as a center and allows the display section 2 to display it (step S3).

The controller 6 changes the display content on the display section 2 according to the user's slide operation (step S4). When an icon on the display section 2 is selected (YES in step S5), the controller 6 requests the server 20 to send the selected music content (step S6). On the other hand, if no reproduction instruction is inputted by the user (No in step S5), the controller 6 changes the display of the music map according to the slide operation (step S4).

The server 20 receives the download request of the music content from the input device 1 and searches for the music content with reference to the music database 22. Upon finding the requested music content, the server 20 sends the music content to the input device 1. The input device 1 receives the music content (step S7) and converts it into a reproducible audio signal (step S8). The speaker 9 outputs a music signal amplified by the amplifier 8 (step S9).

The input device 1 according to the present invention is small enough to be fit in the palm of human hand. When the user moves the input device 1 by one hand on a plain surface, the display content on the display section 2 is changed in accordance with the movement amount of the device. The user confirms the icon of the music content displayed on the display section 2. When finding the desired music content, the user issues an instruction to reproduce it.

In the input device 1 according to the present invention, the operation of sliding the device and the operation of virtually moving the device on the music map are associated with each other, so that the user can intuitively operate the device without the need of learning the operation method.

Further, the input device 1 according to the present invention presents the user the music map on which music contents are classified in terms of age, category, atmosphere, or the like. Even if the user does not know the correct name of the music, he or she can select the music to be reproduced according to broad category classification. That is, the user can perform a music search in an intuitive manner.

In recent years, as described above, a short-range network using a local area wireless communication has become popular. In such a network, data is not stored in respective machines, but is collectively managed by the server 20. A user has only to use a client machine to read out desired data from the server 20 as needed. In the above environment, it is likely that a plurality of client machines are used for one server 20. It is preferable that the client machine be provided with a shape or function according to the use environment.

Since the input device 1 according to the present invention is a small type device, it is possible to always keep it around the user like a remote-controller of TV or air-conditioner. Further, since the input device 1 can be operated on a flat face, it is possible for the user to easily enjoy the music selection operation while relaxing on the sofa or working on the desk.

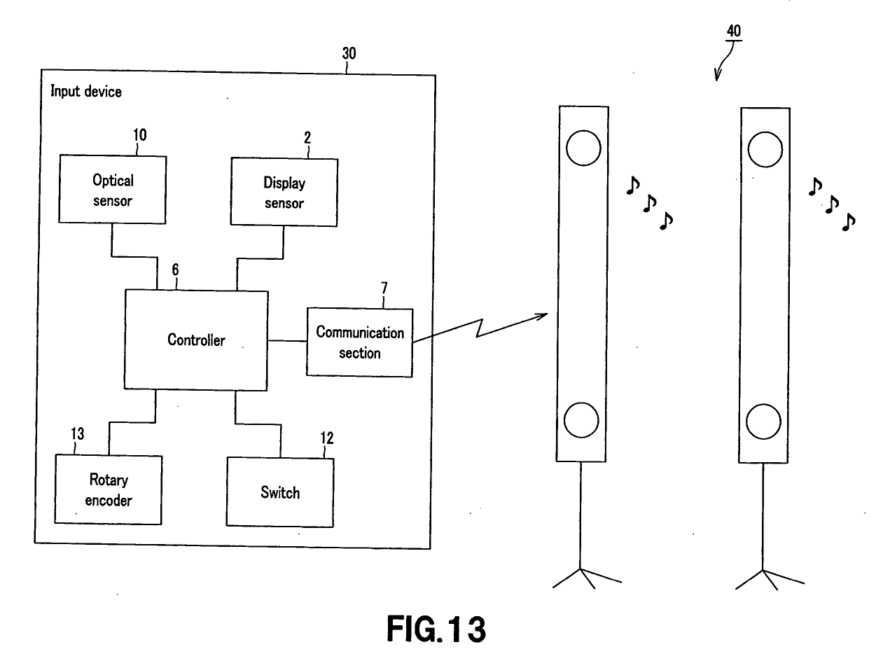

The present invention is characterized by the function that reflects the physical movement of the input device on the virtual movement on the map data 15 and displays it on the display section. Modifications and improvements without departing from the scope of the present invention are included in the invention. For example, as shown in FIG. 13, an input device 30 may include only the controller 6, display section 2, communication section 7, optical sensor 10, rotary encoder 13, and switch 12. In this case, music can be reproduced from an external speaker 40.

Further, it is possible to provide the music database 22 inside the input device 1. In this case, the communication section 7 is unnecessary and a function of searching the music database 22 is added to the controller 6.

The object to be mapped on the map data 15 is not limited to the music content. Other objects such as photograph, motion-image, book may be mapped. For example, photographs may be mapped based on the photographing site, movie posters or book covers may be mapped based on the age or category.

It is possible for the input device 1 to further include a function that receives GUI (Graphical User Interface) to be displayed on a display unit of a personal computer and operates the personal computer through the received GUI.

It should be understood by those skilled in the art that various modifications, combinations, sub-combinations and alternations may occur depending on design requirements and other factors insofar as they are within the scope of the appended claims or the equivalents thereof.

What is claimed is:

1. An input device comprising:
attribute information storage means for storing attribute information of contents;
virtual map creation means for creating a virtual map by allocating, in units of attribute information, icons that represent the contents based on the attribute information;
movement amount detection means for detecting a physical movement amount of the input device;
display control means for calculating the movement amount on the virtual map from the physical movement amount detected by the movement amount detection means and allowing display means to display a predetermined area of the virtual map whose center is the position of the input device on the virtual map after movement; and
input means for inputting identification information of the content corresponding to the icon displayed on the predetermined area as input data when receiving an instruction from a user.

2. The input device according to claim 1, further comprising transfer request means for outputting a transfer request of the content that the identification information input to the input means identifies, to an external device.

3. The input device according to claim 1, further comprising reproduction means for reproducing the content that the identification information input to the input means identifies.

4. The input device according to claim 3, wherein
the content is music content, and
the reproduction means is an amplifier and a speaker.

5. The input device according to claim 1, wherein the virtual map is obtained by allocating icons on map information based on geographic information of the content described in the attribute information.

6. The input device according to claim 1, wherein the virtual map is obtained by allocating icons based on date information of the content described in the attribute information.

7. The input device according to claim 1, wherein the virtual map is obtained by allocating icons based on the category of the content described in the attribute information.

8. An input device comprising:
a cylindrical casing;
a bezel portion rotatably fitted to the upper edge of the casing;
movement amount detection means for detecting the amount of the planar movement of the casing;
attribute information storage means for storing attribute information of contents;
virtual map creation means for creating a virtual map by allocating, in units of attribute information, icons that represent the contents based on the attribute information;
display control means for calculating the movement amount on the virtual map from the physical movement amount and allowing display means to display a predetermined area of the virtual map whose center is the position of the input device on the virtual map after movement; and
input means for inputting identification information of the content corresponding to the icon displayed on the predetermined area as input data when receiving an instruction from a user.

9. The input device according to claim 8, further comprising transfer request means for outputting a transfer request of the content that the identification information input to the input means identifies, to an external device.

10. The input device according to claim 8, wherein the input means receives a user's instruction through the rotation amount of the bezel portion.

11. The input device according to claim 8, wherein the input means receives a user's instruction through the depression applied on the bezel portion.

12. The input device according to claim 8, further comprising reproduction means for reproducing the content that the identification information input to the input means identifies.

13. The input device according to claim 12, wherein
the content is music content, and
the reproduction means is an amplifier and a speaker.

14. An input device comprising:
an attribute information storage section that stores attribute information of contents;
a virtual map creation section that creates a virtual map by allocating, in units of attribute information, icons that represent the contents based on the attribute information;
a movement amount detection section that detects a physical movement amount of the input device;
a display controller that calculates the movement amount on the virtual map from the physical movement amount detected by the movement amount detection section and allows a display section to display a predetermined area of the virtual map whose center is the position of the input device on the virtual map after movement; and
an input section that inputs identification information of the content corresponding to the icon displayed on the predetermined area as input data when receiving an instruction from a user.

15. An input device comprising:
a cylindrical casing;
a bezel portion rotatably fitted to the upper edge of the casing;
a movement amount detection section that detects the amount of the planar movement of the casing;
an attribute information storage section that stores attribute information of contents;
a virtual map creation section that creates a virtual map by allocating, in units of attribute information, icons that represent the contents based on the attribute information;
a display controller that calculates the movement amount on the virtual map from the physical movement amount and allows a display section to display a predetermined area of the virtual map whose center is the position of the input device on the virtual map after movement; and
an input section that inputs identification information of the content corresponding to the icon displayed on the predetermined area as input data when receiving an instruction from a user.
